(19) United States
(12) Patent Application Publication
(10) Pub. No.: US 2012/0293559 A1
(43) Pub. Date: Nov. 22, 2012

(54) MAP SCROLLING DEVICE

(75) Inventors: Yoshihiro Tomaru, Tokyo (JP); Makoto Otsuru, Tokyo (JP)

(73) Assignee: Mitsubishi Electric Corporation, Tokyo (JP)

(21) Appl. No.: 13/575,034

(22) PCT Filed: Feb. 23, 2010
(86) PCT No.: PCT/JP2010/001208

§ 371 Date: Jul. 25, 2012

(51) Int. Cl. G09G 5/00

(52) U.S. Cl. 345/684

(57) ABSTRACT

A prefetch size for drawing calculating unit 6 determines a prefetch size for drawing on the basis of a scroll speed and a scroll direction. A prefetch area for drawing calculating unit 7 determines a prefetch area for drawing from the scroll speed, the scroll direction, and the prefetch size for drawing. A back-side drawing memory 11 stores map data about the prefetch area for drawing, and is interchanged with a front-side drawing memory 12. A rectangle extracting unit 14 extracts a rectangular area for display from the front-side drawing memory 12 with which the back-side drawing memory is interchanged, and this rectangular area for display is displayed by a display unit 15.

### FIELD OF THE INVENTION

The present invention relates to a map scrolling device which can prevent a blank map from appearing when scrolling a map displayed thereon.

### BACKGROUND OF THE INVENTION

When a scroll of a map causes a rectangular area for display to go beyond a determination area larger than the rectangular area for display, a map scrolling device in a conventional map display device prefetches data about a map area in a direction of the scroll and draws this map data to smoothly implement the scroll (e.g. refer to patent reference 1). More specifically, when the user scrolls the on-screen map to the right and the rectangular area for display goes beyond the prefetch determination area, the map scrolling device reads only data about a map area existing in a rightward direction in a memory area for prefetching and drawing, and draws the map data. By prefetching only the data in this way, the map scrolling device prevents the rectangular area for display from extending off a drawn area even when the map is scrolled at a high speed to avoid the blank map problem resulting from the rectangular area for display reaching a not-drawn area. The appearance of a blank map is a phenomenon in which the on-screen map partially has no map information.

### RELATED ART DOCUMENT

### Patent Reference

Patent reference 1: Japanese Unexamined Patent Application Publication No. JP 09-16156 A

A problem with the above-mentioned conventional map scrolling device is, however, that when there are many map data to be prefetched, the processing load required to carry out the prefetching and drawing is high and the drawing is not completed by the time the rectangular area for display is made to reach the data-prefetched area with a scroll of the on-screen map, and this results in the appearance of a blank map. The present invention is made in order to solve the above-mentioned problem, and it is therefore an object of the present invention to provide a map scrolling device which reduces the drawing load imposed thereon and speeds up its drawing operation by changing a prefetch area for drawing and a prefetch for drawing position adaptively according to a scroll speed and a scroll direction, thereby preventing the appearance of a blank map.

### SUMMARY OF THE INVENTION

Because a map scrolling device in accordance with the present invention determines a prefetch area for drawing on the basis of a scroll speed and a scroll direction, the map scrolling device reduces the drawing load imposed thereon and speeds up its drawing operation, thereby preventing the appearance of a blank map.

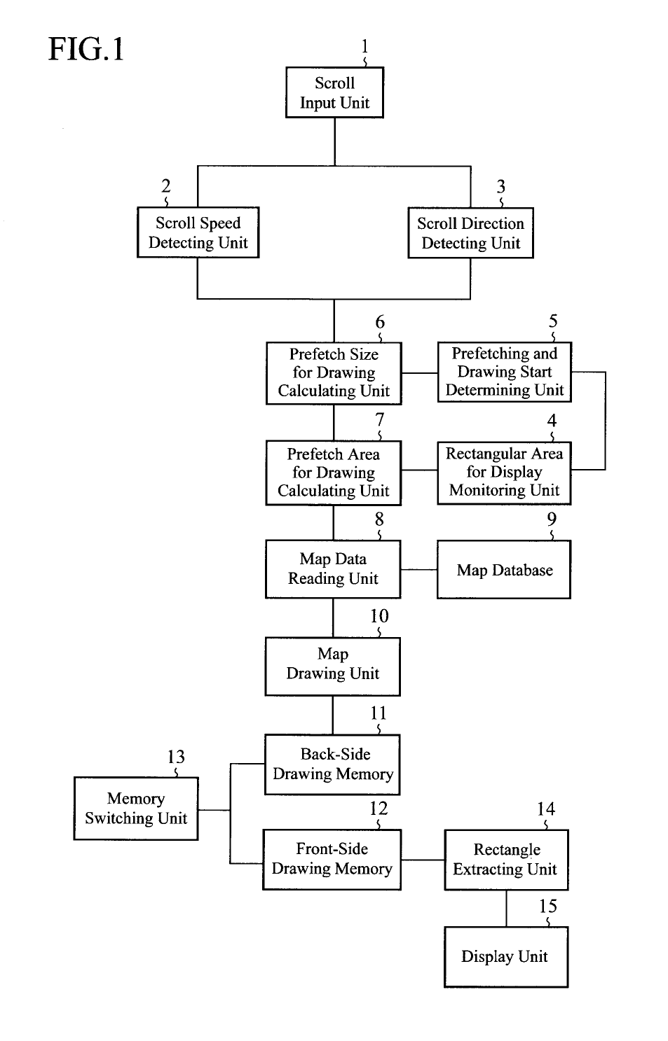

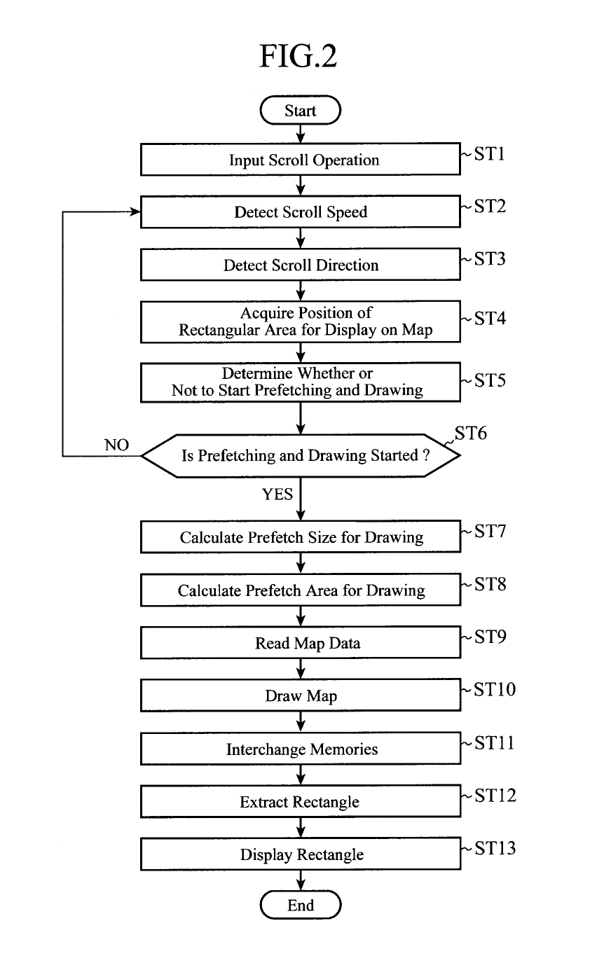

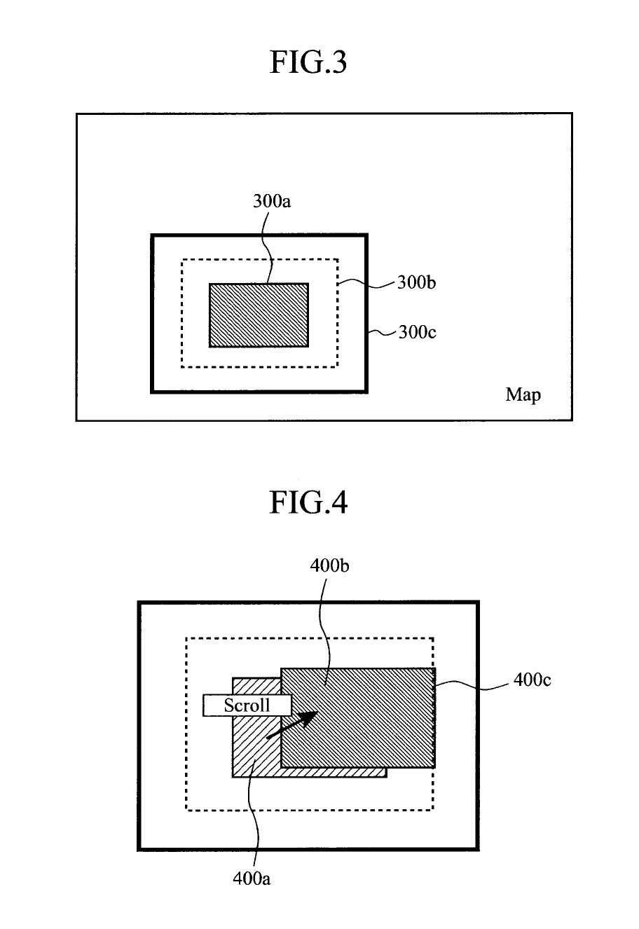

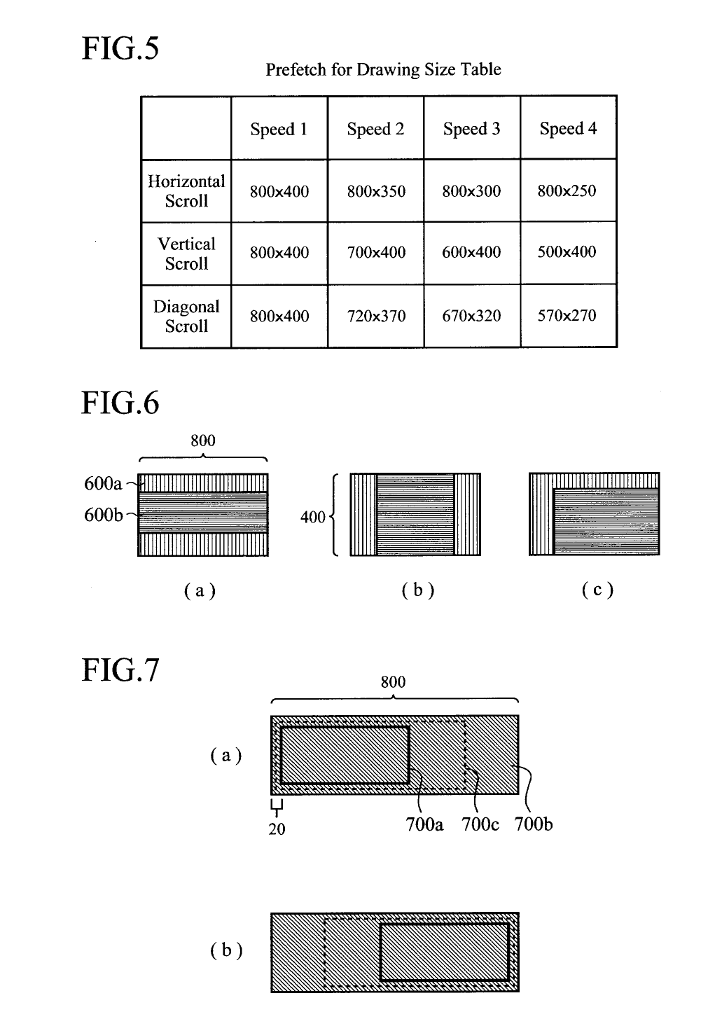

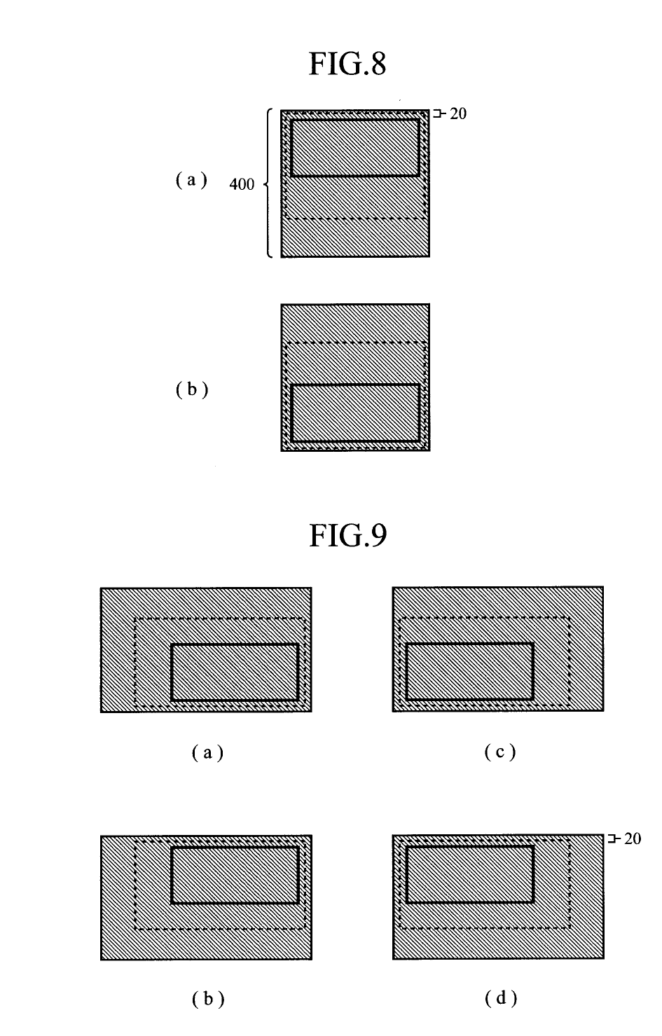

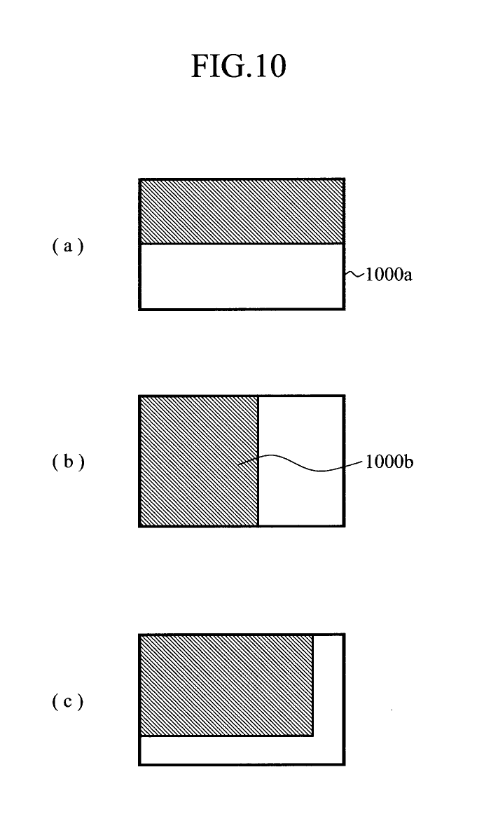

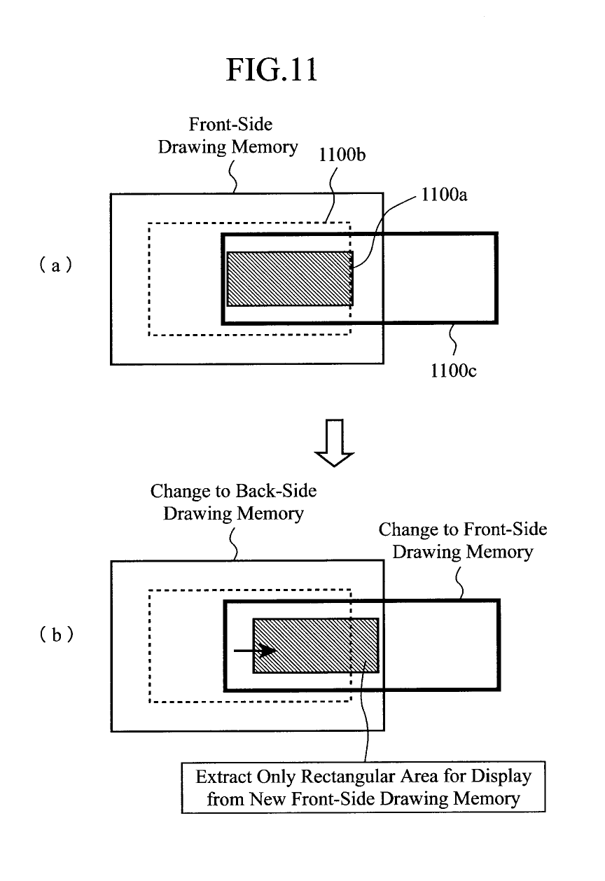

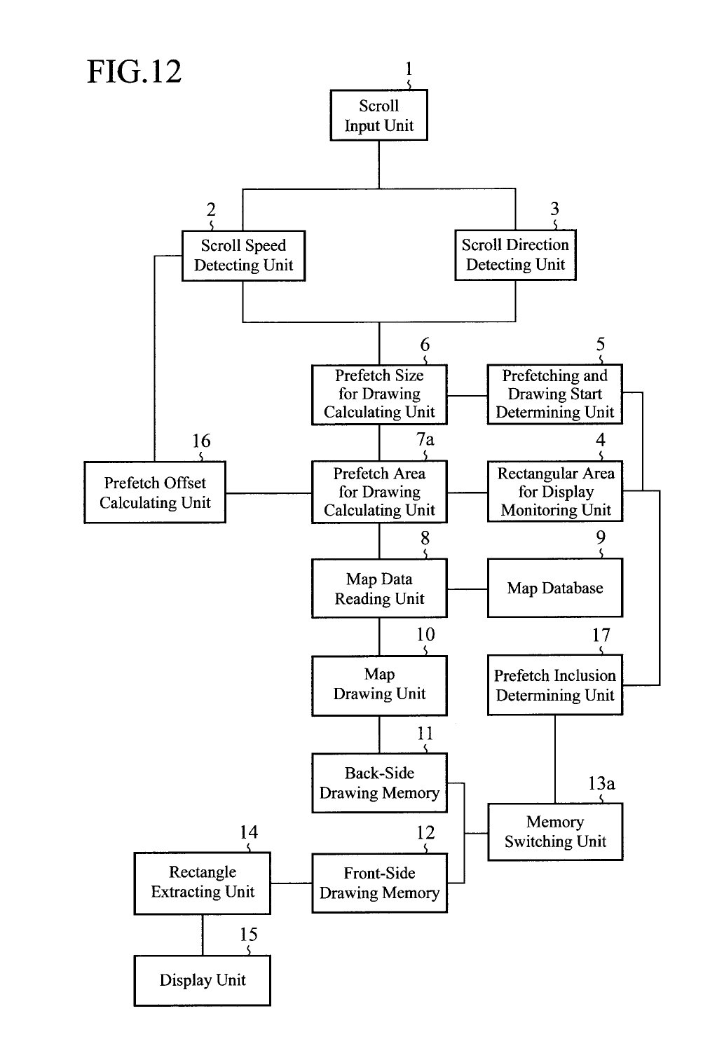

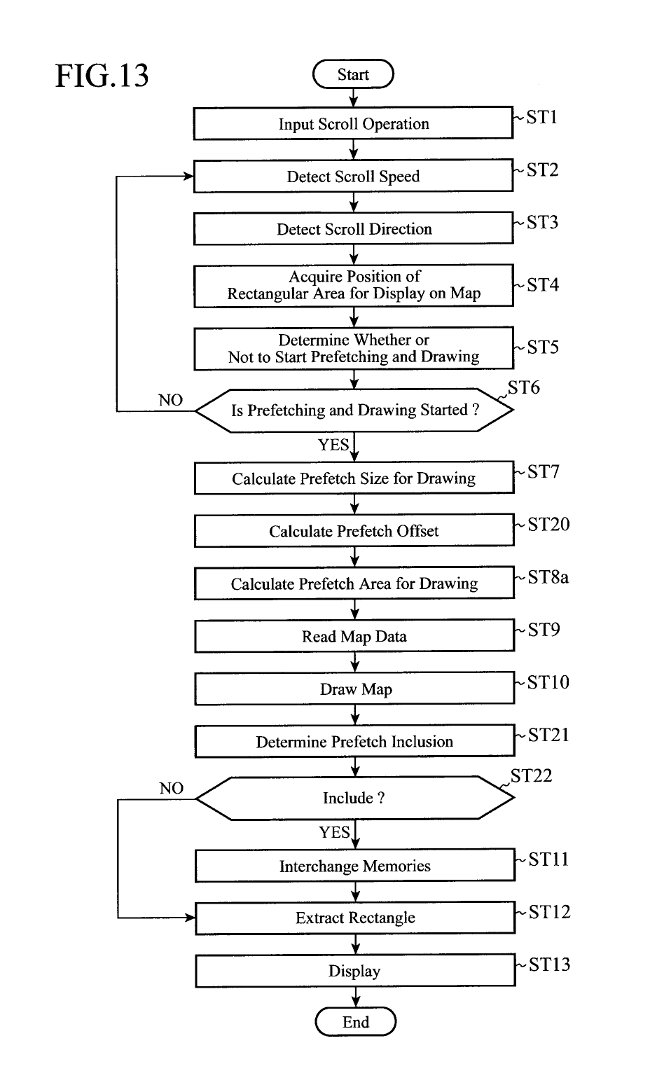

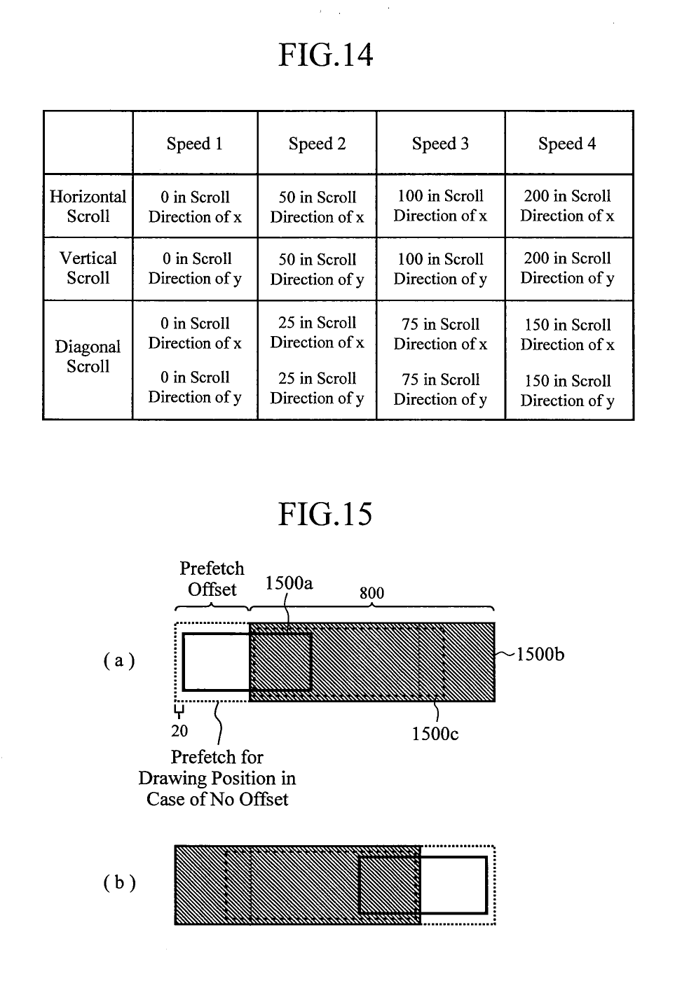

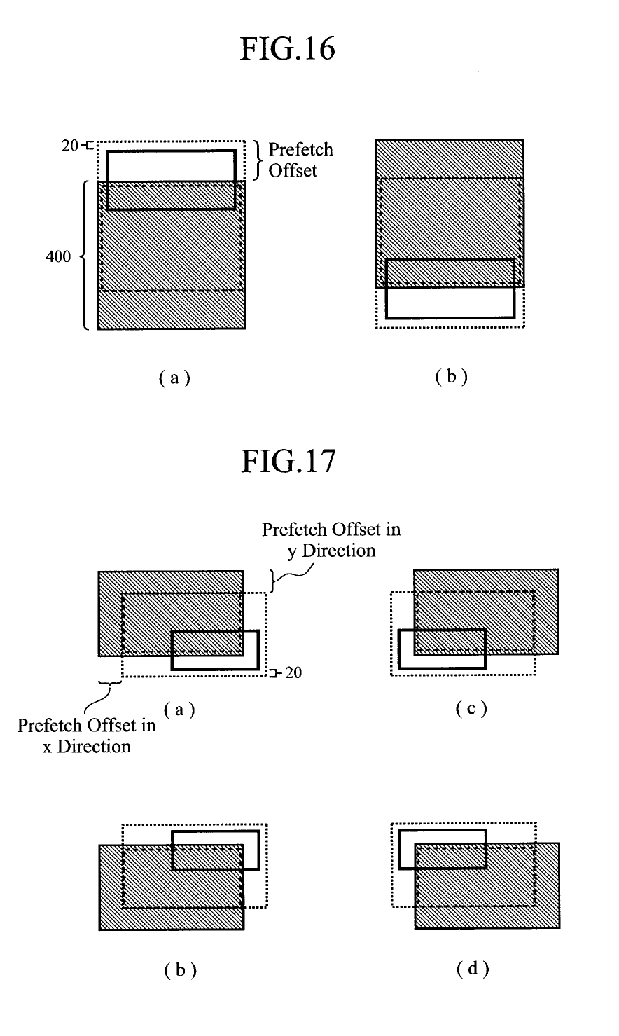

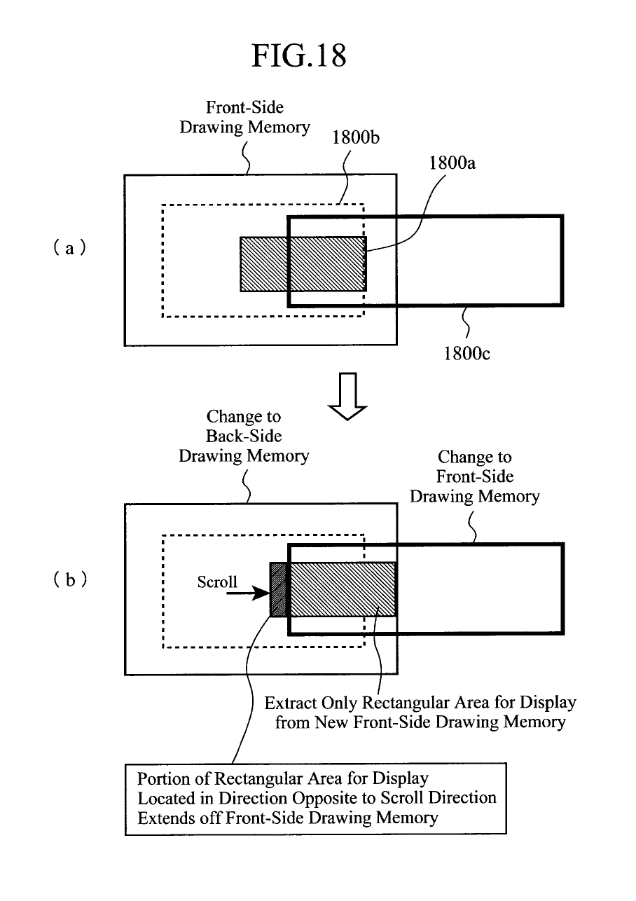

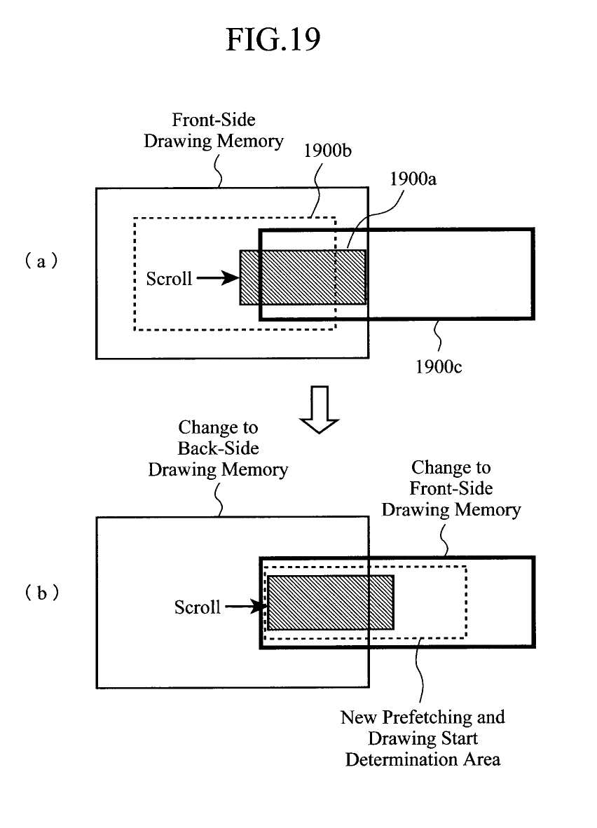

### BRIEF DESCRIPTION OF THE FIGURES

[FIG. 1] FIG. 1 is a block diagram showing a map scrolling device in accordance with Embodiment 1 of the present invention;

[FIG. 2] FIG. 2 is a flow chart showing the operation of the map scrolling device in accordance with Embodiment 1 of the present invention;

[FIG. 3] FIG. 3 is an explanatory drawing showing a positional relationship among a map drawn in a front-side drawing memory of the map scrolling device in accordance with Embodiment 1 of the present invention, a rectangular area for display, and a prefetching and drawing start determination area;

[FIG. 4] FIG. 4 is an explanatory drawing of an operation of determines whether the rectangular area for display of the map scrolling device in accordance with Embodiment 1 of the present invention has gone beyond the prefetching and drawing start determination area;

[FIG. 5] FIG. 5 is an explanatory drawing of a prefetch for drawing size table of the map scrolling device in accordance with Embodiment 1 of the present invention;

[FIG. 6] FIG. 6 is an explanatory drawing showing a relationship between a front-side drawing memory or a back-side drawing memory of the map scrolling device in accordance with Embodiment 1 of the present invention, and the prefetch size for drawing for each scroll direction;

[FIG. 7] FIG. 7 is an explanatory drawing showing a relationship among a prefetch for drawing position at the time of a horizontal scroll, a position of the rectangular area for display on the map, and the prefetching and drawing start determination area in the map scrolling device of Embodiment 1 of the present invention;

[FIG. 8] FIG. 8 is an explanatory drawing showing a prefetch for drawing position at the time of a vertical scroll in the map scrolling device in accordance with Embodiment 1 of the present invention;

[FIG. 9] FIG. 9 is an explanatory drawing showing a prefetch for drawing position at the time of a diagonal scroll in the map scrolling device in accordance with Embodiment 1 of the present invention;

[FIG. 10] FIG. 10 is an explanatory drawing showing a drawing area in which map data is drawn of the back-side drawing memory of the map scrolling device in accordance with Embodiment 1 of the present invention;

[FIG. 11] FIG. 11 is an explanatory drawing showing a relationship between the front-side drawing memory and the back-side drawing memory at the time of start of prefetching and drawing and at the time of completion of the prefetching and drawing in the map scrolling device in accordance with Embodiment 1 of the present invention;

[FIG. 12] FIG. 12 is a block diagram showing a map scrolling device in accordance with Embodiment 2 of the present invention;

[FIG. 13] FIG. 13 is a flow chart showing the operation of the map scrolling device in accordance with Embodiment 2 of the present invention;

[FIG. 14] FIG. 14 is an explanatory drawing showing a prefetch offset table of the map scrolling device in accordance with Embodiment 2 of the present invention;

[FIG. 15] FIG. 15 is an explanatory drawing showing a relationship between a prefetch offset and a prefetch for drawing position in the map scrolling device in accordance with Embodiment 2 of the present invention;

[FIG. 16] FIG. 16 is an explanatory drawing showing a prefetch for drawing position at the time of a vertical scroll in the map scrolling device in accordance with Embodiment 2 of the present invention;

[FIG. 17] FIG. 17 is an explanatory drawing showing a prefetch for drawing position at the time of a diagonal scroll in the map scrolling device in accordance with Embodiment 2 of the present invention;

[FIG. 18] FIG. 18 is an explanatory drawing in a case of determining whether or not a rectangular area for display in the map scrolling device of Embodiment 2 of the present invention is fully included in a prefetch area for drawing; and

[FIG. 19] FIG. 19 is an explanatory drawing showing an interchange between a front-side drawing memory and a back-side drawing memory at the time of completion of prefetching and drawing and at the time that the rectangular area for display is fully included in the prefetch area for drawing in the map scrolling device in accordance with Embodiment 2 of the present invention.

### EMBODIMENTS OF THE INVENTION

Hereafter, in order to explain this invention in greater detail, the preferred embodiments of the present invention will be described with reference to the accompanying drawings.

### Embodiment 1

FIG. 1 is a block diagram of a map scrolling device in accordance with this embodiment. Referring to FIG. 1, a scroll input unit 1 is direction key input unit for accepting a map scroll operation, such as a touch panel or a remote control. A scroll speed detecting unit 2 is a means for determining a scroll speed on the basis of a scroll operation inputted from the scroll input unit 1. A scroll direction detecting unit 3 is a means for determining a scroll direction on the basis of the scroll operation inputted from the scroll input unit 1. A rectangular area for display monitoring unit 4 is a means for monitoring a position on a map displayed on a screen. A prefetching and drawing start determining unit 5 is a means for comparing the position of the rectangular area for display with a prefetching and drawing start determination area to determine whether or not to perform a prefetch operation. A prefetch size for drawing calculating unit 6 is a means for performing a prefetch operation on the basis of the detected scroll speed and the detected scroll direction to determine a map size in which to draw a map. A prefetch area for drawing calculating unit 7 is a means for determining a prefetch area for drawing from the calculated drawing size and the position of the rectangular area for display. A map data reading unit 8 is a means for reading map data corresponding to the determined prefetch area for drawing from a map database 9. The map database 9 stores a map to be displayed. A map drawing unit 10 is a means for writing the map data read in a back-side drawing memory 11. A memory interchanging unit 13 is a means for interchanging a front-side drawing memory 12 and the back-side drawing memory 11 when the drawing of map data in the back-side drawing memory 11 is completed. A rectangle extracting unit 14 is a means for extracting an area having the same size as the rectangular area for display from the front-side drawing memory 12. A display unit 15 is a map display unit, such as a liquid crystal display, and is a means for displaying the area extracted by the rectangle extracting unit 14.

Next, the operation of the map scrolling device in accordance with Embodiment 1 will be explained with reference to a flow chart of FIG. 2. In this Embodiment, it is assumed that map coordinates in a rightward direction of a horizontal axis x are positive and map coordinates in an upward direction of a vertical axis y are positive, the rectangular area for display on the display unit 15 has a size of 40×200, both the front-side drawing memory 12 and the back-side drawing memory 11 have a size of 800×400, the prefetching and drawing start determination area has a size of 600×300, and the scroll speed is rated on a scale of four speeds from speed 1 to speed 4 (the speed 1 is the slowest speed, and the speed 4 is the fastest speed). The front-side drawing memory 12 and the back-side drawing memory 11 are memory areas on a VRAM. It is further assumed that the drawing of a map in the front-side drawing memory 12 has been completed, and there is a positional relationship as shown in FIG. 3 among the map drawn in the front-side drawing memory 12, the rectangular area for display, and the prefetching and drawing start determination area. In FIG. 3, 300a denotes the position of the rectangular area for display on the map, 300b denotes the prefetching and drawing start determination area, and 300c denotes the position of the map which is drawn in the front-side drawing memory 12.

First, the scroll operation input unit 1 acquires a user's scroll operation (step ST1). Typically, the scroll operation is the one performed on a touch panel, or a key operation performed on the remote control. The scroll speed detecting unit 2 then detects the scroll speed on the basis of a scroll input (step ST2). In the case of the touch panel, the scroll speed detecting unit determines the speed from the distance between the part of the touch panel where the user has touched and the screen center in such a way that the speed increases with the distance. In the case of a key input using the remote control, the scroll speed detecting unit determines the speed from the time period during which the user has been pushing down the remote control direction key in such a way that the speed increases with the length of the time period. After the scroll speed detecting unit has completed the detection of the scroll speed, the scroll direction detecting unit 3 carries out detection of the scroll direction (step ST3). In the case of the touch panel, the scroll direction detecting unit determines the direction from the screen center to the part where the user has touched as the scroll direction. In the case of a key input using the remote control, the scroll direction detecting unit determines the direction of the direction key of the remote control which the user has pushed down (typically, the remote control has 8 direction keys) as the scroll direction.

Next, the rectangular area for display monitoring unit 4 acquires the position of the rectangular area for display on the map (step ST4). The position of the rectangular area for display is the map xy coordinates of the four vertices of the rectangular area for display. The prefetching and drawing start determining unit 5 then compares the position of the rectangular area for display with the prefetching and drawing start determination area to carry out prefetching and drawing start determination (step ST5). More specifically, the prefetching and drawing start determining unit determines whether the rectangular area for display has gone beyond the prefetching and drawing start determination area, resulting from the scroll operation, as shown in FIG. 4, and, when the rectangular area for display has gone beyond the prefetching and drawing start determination area, determines to start a prefetching and drawing operation (step ST6). In FIG. 4, 400a denotes the position of the rectangular area for display before the scroll is performed, 400b denotes the position of the rectangular area for display after the scroll is performed, and 400c denotes a part of the rectangular area for display which has extended off the prefetching and drawing start determination area. Further, the prefetching and drawing start determining unit can determine whether the rectangular area for display has gone beyond the prefetching and drawing start determination area according to the following equation 1. When the equation returns true, the prefetching and drawing start determining unit determines that the rectangular area for display has gone beyond the prefetching and drawing start determination area, whereas the equation returns false, the prefetching and drawing start determining unit determines that the rectangular area for display has not gone beyond the prefetching and drawing start determination area.

(disp_{—}1≦thres_{—}1)∪(thres_{—}≦rdisp_{—}r)∪(disp_{—}b≦thres_{—}b)∪(thres_{—}t≦disp_{—}t) (equation 1)

where disp_{—}1, disp_r, disp_b, and disp_t are the left end x-coordinate, the right end x-coordinate, the lower end y coordinate, and the upper end y coordinate of the rectangular area for display, and thres_{—}1, thres_r, thres_b, and thres_t are the left end x-coordinate, the right end x-coordinate, the lower end y coordinate, and the upper end y coordinate of the prefetching and drawing start determination area.

When the result of the prefetching and drawing start determination of step ST6 shows that no prefetching and drawing is started, the map scrolling device redoes the processing from the scroll speed detection of step ST2. In contrast, when the result of the prefetching and drawing start determination shows that prefetching and drawing is started, the prefetch size for drawing calculating unit 6 calculates the prefetch size for drawing (step ST7). The prefetch size for drawing calculating unit determines the prefetch size for drawing dependently upon the scroll speed detected by the scroll speed detecting unit 2 and the scroll direction detected by the scroll direction detecting unit 3. More specifically, the prefetch size for drawing calculating unit determines the prefetch size for drawing by using a prefetch for drawing size table. When the scroll speed is rated on a scale of four speeds, the prefetch size for drawing calculating unit uses a prefetch for drawing size table as shown in FIG. 5. Because there is a low probability that the rectangular area for display moves in a direction other than the scroll direction when the scroll speed is large, the prefetch for drawing size table is set up in such a way that greater importance is placed on narrowing the drawing area except an area extending in the scroll direction with increase in the scroll speed. For example, when scrolling the map horizontally, upper and lower sides of the drawing area are removed from the drawing area, whereas when scrolling the map vertically, right and left sides of the drawing area are removed from the drawing area. Further, although when scrolling the map in a diagonal direction, sides in both horizontal and vertical directions of the drawing area are removed from the drawing area, each of the sides has a size which is about half of those in a vertical scroll and in a horizontal scroll because there is a possibility that the rectangular area for display moves in both horizontal and vertical directions. Further, the prefetch size for drawing is certainly set to be equal to or smaller than the size of the front-side drawing memory 12 and that of the back-side drawing memory 11 (refer to FIG. 6). In FIG. 6, (a) shows the prefetch size for drawing which is determined at the time of a horizontal scroll, (b) shows the prefetch size for drawing which is determined at the time of a vertical, scroll, and (c) shows the prefetch size for drawing which is determined at the time of a diagonal scroll. Further, 600a denotes the original prefetch size for drawing, and 600b denotes the new prefetch size for drawing.

After the prefetch size for drawing calculating unit 6 determines the prefetch size for drawing, the prefetch area for drawing calculating unit 7 calculates the prefetch area for drawing on the map (step ST8). The prefetch area for drawing calculating unit carries out the calculation of the prefetch area for drawing by using the prefetch size for drawing, the rectangular area for display position, and the scroll direction. In the case of a horizontal scroll, the prefetch area for drawing is determined in such a way that the center of the rectangular area for display has the same y coordinate as that of the prefetch area for drawing, and is placed in such a way that the gap between the opposite sides of both the rectangular areas in a direction opposite to the scroll direction is 20 pixels. Simultaneously, the prefetching and drawing start determination area which is to be set up when the prefetching and drawing is completed is also calculated. The prefetching and drawing start determination area can consist of four sides each of which is positioned intermediate between the corresponding one of the four sides of the rectangular area for display and the corresponding one of the four sides of the prefetch area for drawing (refer to FIG. 7). FIG. 7 shows the prefetch for drawing position at the time of a horizontal scroll. In the figure, (a) shows the prefetch for drawing position at the time of a rightward horizontal scroll, and (b) shows the prefetch for drawing position at the time of a leftward horizontal scroll. Further, 700a denotes the position of the rectangular area for display on the map, 700b denotes the prefetch for drawing position, and 700c denotes the prefetching and drawing start determination area which becomes effective when the prefetching and drawing is completed. Also in the case of a vertical scroll or a diagonal scroll, the prefetch area for drawing calculating unit similarly determines the prefetch area for drawing and the prefetching and drawing start determination area (refer to FIGS. 8 and 9). In FIG. 8, (a) shows the prefetch for drawing position at the time of a downward vertical scroll, and (b) shows the prefetch for drawing position at the time of an upward vertical scroll. In FIG. 9, (a) shows the prefetch for drawing position at the time of a left-upward diagonal scroll, (b) shows the prefetch for drawing position at the time of a left-downward diagonal scroll, (c) shows the prefetch for drawing position at the time of a right-upward diagonal scroll, and (d) shows the prefetch for drawing position at the time of a right-downward diagonal scroll. The gap between the opposite sides of the rectangular area for display and the prefetch area for drawing does not necessarily need to be 20 pixels, and can be about tens of pixels as long as both the sides are positioned as close to each other as possible.

After the prefetch area for drawing is calculated, the map data reading unit 8 acquires the map data corresponding to the prefetch area for drawing from the map database 9 (step ST9). The map data reading unit sends the map data acquired to the map drawing unit 10, and the map drawing unit 10 draws the map data in the back-side drawing memory 11 (step ST10). Although the acquired map data differs in size according to the scroll speed and the scroll direction, the map drawing unit certainly draws the map data in the back-side drawing memory 11 from the upper left end of this memory (refer to FIG. 10). In FIG. 10, (a) shows the map data drawn in the memory at the time of a horizontal scroll, (b) shows the map data drawn in the memory at the time of a vertical scroll, and (c) shows the map data drawn in the memory at the time of a diagonal scroll. Further, 1000a denotes the area of the back-side drawing memory 11, and 1000b denotes the area in which the map data is drawn.

After the drawing of the map data in the back-side drawing memory 11 is completed, the memory interchanging unit 13 interchanges the front-side drawing memory 12 and the back-side drawing memory 11 (step ST11). Then, the back-side drawing memory 11 in which the map data prefetched is drawn serves as the new front-side drawing memory 12, and the rectangle extracting unit 14 displays the rectangle on the map corresponding to the rectangular area for display position on the display unit 15 (step ST12, ST13). For example, when a rightward scroll is carried out as shown in FIG. 11, a map of the prefetch area for drawing according to the scroll direction and the scroll speed is drawn in the back-side drawing memory 11 at the time when the prefetching and drawing is started, and the back-side drawing memory 11 and the front-side drawing memory 12 are interchanged when the drawing of the map is completed. Then, because the back-side drawing memory 11 is updated to the new front-side drawing memory 12 in which the map is drawn in large size with respect to the scroll direction while the rectangular area for display is moving in a rightward direction, the rectangular area for display is prevented from extending off toward the non-drawing area. In FIG. 11, (a) shows the front-side and back-side drawing memories at the time when the prefetching and drawing is started, (b) shows the front-side and back-side drawing memories at the time when the prefetching and drawing is completed. Further, 1100a denotes the rectangular area for display, 1100b denotes the prefetching and drawing start determination area, and 1100c denotes the area which is drawn in the back-side drawing memory 11.

As mentioned above, because the map scrolling device in accordance with Embodiment 1 removes an unnecessary drawing area according to the scroll direction and the scroll speed, thereby reducing the drawing load imposed thereon, the map scrolling device can carry out prefetching and drawing at a high speed even when there are a large number of processes for map drawing. Further, because the map scrolling device provides a large drawing area for the scroll direction, the map scrolling device can prevent the rectangular area for display from extending off the drawing area, and reduce the occurrence of a blank map.

As mentioned above, the map scrolling device in accordance with Embodiment 1 includes the scroll detecting unit for detecting the scroll speed of a scroll operation performed on a displayed map, the scroll direction detecting unit for detecting the scroll direction of the scroll operation, the rectangular area for display monitoring unit for acquiring the position of a rectangular area for display on the map, the prefetching and drawing start determining unit for determining whether or not to carry out prefetching and drawing from the position of the rectangular area for display on the map, the prefetch size for drawing calculating unit for determining the prefetch size for drawing from the scroll speed and the scroll direction, the prefetch area for drawing calculating unit for determining the prefetch area for drawing from the scroll speed, the scroll direction, and the prefetch size for drawing, the map data reading unit for reading map data about a map of the prefetch area for drawing, the map drawing unit for drawing the map data read in the back-side drawing memory, the memory interchanging unit for interchanging the back-side drawing memory with the front-side drawing memory, the rectangle extracting unit for extracting a rectangle corresponding to a map of the rectangular area for display from the front-side drawing memory with which the back-side drawing memory is interchanged, and the display unit for displaying the rectangle extracted. Therefore, the map scrolling device can prevent a blank map from appearing and can also reduce the drawing load imposed thereon, thereby being able to speed up the drawing.

Further, because in the map scrolling device in accordance with Embodiment 1 the prefetching and drawing start determining unit determines whether or not to carry out the prefetching and drawing by determining whether the rectangular area for display has gone beyond a predetermined prefetching and drawing start determination area, the map scrolling device can surely determine whether or not to start the prefetching and drawing.

Further, because in the map scrolling device in accordance with Embodiment 1 the prefetch size for drawing calculating unit determines the prefetch size for drawing by making reference to a prefetch for drawing size table showing prefetch sizes for drawing each of which is predetermined according to a scroll direction and a scroll speed, the map scrolling device can determine the prefetch size for drawing more precisely.

Further, because in the map scrolling device in accordance with Embodiment 1 the prefetch area for drawing calculating unit calculates the prefetch area for drawing from the scroll direction, the scroll speed, the prefetch size for drawing, and the rectangular area for display position in such a way that portions of the prefetch area for drawing except that extending in the scroll direction are reduced in size and the prefetch area for drawing is biased toward the scroll direction, the map scrolling device can further reduce the appearance of a blank map.

Further, because in the map scrolling device in accordance with Embodiment 1 the memory interchanging unit interchanges the back-side drawing memory and the front-side drawing memory at a time when the prefetching and drawing is completed, the map scrolling device can surely prevent a blank map from appearing.

### Embodiment 2

Although in above-mentioned Embodiment 1 the map scrolling device which optimizes the prefetch area for drawing according to the scroll direction and the scroll speed is shown, a map scrolling device which can reduce the appearance of a blank map even in a case in which the scroll speed is very high and therefore the rectangular area for display has gone beyond the prefetch area for drawing even if the method in accordance with Embodiment 1 is used will be explained below as Embodiment 2.

FIG. 12 is a block diagram of the map scrolling device in accordance with Embodiment 2, and the map scrolling device will be explained with reference to this FIG. 12. Referring to FIG. 12, a prefetch offset calculating unit 16 is a means for determining a prefetch offset used for determining a prefetch for drawing position from both a scroll speed detected by a scroll speed detecting unit 2 and a scroll direction detected by a scroll direction detecting unit 3. Further, a prefetch area for drawing calculating unit 7a is constructed in such a way as to determine a prefetch area for drawing from a drawing size determined by a prefetch size for drawing calculating unit 6, the prefetch offset calculated by the prefetch offset calculating unit 16, and the position of a rectangular area for display acquired by a rectangular area for display monitoring unit 4. In addition, a prefetch inclusion determining unit 17 is a means for determining whether or not the rectangular area for display is fully included in the prefetch area for drawing on the basis of the position of the rectangular area for display acquired by the rectangular area for display monitoring unit 4. Further, a memory interchanging unit 13a is constructed in such a way as to interchange a front-side drawing memory 12 and a back-side drawing memory 11 when the prefetch inclusion determining unit 17 determines that the rectangular area for display is fully included in the prefetch area for drawing. Because the other structural components are the same as those in accordance with Embodiment 1 shown in FIG. 1, the corresponding components are designated by the same reference numerals as those shown in the figure and the explanation of the components will be omitted hereafter.

Next, the operation of the map scrolling device in accordance with Embodiment 2 will be explained with reference to a flow chart of FIG. 13. In Embodiment 2, it is assumed that map coordinates in a rightward direction of a horizontal axis x are positive and map coordinates in an upward direction of a vertical axis y are positive, the rectangular area for display on a display unit 15 has a size of 400×200, both the front-side drawing memory 12 and the back-side drawing memory 11 have a size of 800×400, a prefetching and drawing start determination area has a size of 600×300, and the scroll speed is rated on a scale of four speeds from speed 1 to speed 4, like in Embodiment 1. The front-side drawing memory 12 and the back-side drawing memory 11 are memory areas on a VRAM. It is further assumed that the drawing of a map in the front-side drawing memory 12 has been completed, and there is a positional relationship as shown in FIG. 3 among a map drawn in the front-side drawing memory 12, the rectangular area for display, and the prefetching and drawing start determination area.

Because the map scrolling device in accordance with this embodiment carries out processes including up to the determination of the prefetch size for drawing in step ST7 in completely the same way that the map scrolling device in accordance with Embodiment 1 does, the explanation of the processes including up to the determination of the prefetch size for drawing will be omitted hereafter. After the prefetch size for drawing is determined, the prefetch offset calculating unit 16 calculates the prefetch offset (step ST20). The prefetch offset calculating unit receives the scroll speed and the scroll direction as inputs thereof, and determines the prefetch offset by using a preset prefetch offset table as shown in FIG. 14. The prefetch offset table can be determined from map display specifications, such as the size of the rectangular area for display and actual scroll speeds (how many pixels the map is scrolled for each frame), and a system producer can set proper values to the prefetch offset table.

Next, the prefetch area for drawing calculating unit 7a calculates the prefetch area for drawing (step ST8a). The prefetch area for drawing calculating unit carries out the calculation of the prefetch area for drawing by using the prefetch size for drawing, the prefetch offset, the position of the rectangular area for display, and the scroll direction. In the case of a horizontal scroll, while the prefetch area for drawing is determined in such a way that the center of the rectangular area for display has the same y coordinate as that of the prefetch area for drawing, and is placed in such a way that the gap between the opposite sides of both the rectangular areas in a direction opposite to the scroll direction is 20 pixels, like in Embodiment 1, the rectangular area for display is shifted again by the prefetch offset in the scroll direction. Simultaneously, while the prefetching and drawing start determination area which is to be set up when the prefetching and drawing is completed is also calculated, the prefetching and drawing start determination area, which is determined in the same way as that shown in Embodiment 1, is also shifted by the prefetch offset (refer to FIG. 15). FIG. 15 shows the prefetch for drawing position at the time of a horizontal scroll. In the figure, (a) shows the prefetch for drawing position at the time of a rightward horizontal scroll, and (b) shows the prefetch for drawing position at the time of a leftward horizontal scroll. Further, 1500a denotes the position of the rectangular area for display on the map, 1500b denotes the prefetch for drawing position, and 1500c denotes the prefetching and drawing start determination area which becomes effective when the back-side drawing memory 11 on which the prefetching and drawing has been carried out is interchanged with the front-side drawing memory 12. Also in the case of a vertical scroll or a diagonal scroll, the prefetch area for drawing calculating unit similarly determines the prefetch area for drawing and the prefetching and drawing start determination area (refer to FIGS. 16 and 17). In FIG. 16, (a) shows the prefetch for drawing position at the time of a downward vertical scroll, and (b) shows the prefetch for drawing position at the time of an upward vertical scroll. In FIG. 17, (a) shows the prefetch for drawing position at the time of a left-upward diagonal scroll, (b) shows the prefetch for drawing position at the time of a left-downward diagonal scroll, (c) shows the prefetch for drawing position at the time of a right-upward diagonal scroll, and (d) shows the prefetch for drawing position at the time of a right-downward diagonal scroll. The gap between the opposite sides of the rectangular area for display and the prefetch area for drawing without the prefetch offset does not necessarily need to be 20 pixels, and can be about tens of pixels as long as both the sides are positioned as close to each other as possible.

After the prefetch area for drawing is calculated, a map data reading unit 8 acquires the map data corresponding to the prefetch area for drawing from a map database 9 (step ST9). The map data reading unit sends the map data acquired to a map drawing unit 10, and the map drawing unit 10 draws the map data in the back-side drawing memory 11 (step ST10). Although the acquired map data differs in size according to the scroll speed and the scroll direction, the map drawing unit certainly draws the map data in the back-side drawing memory 11 from the upper left end of this memory (refer to FIG. 10). After the drawing of the map in the back-side drawing memory 11 is completed, the prefetch inclusion determination unit 17 determines whether or not the rectangular area for display is fully included in the prefetch area for drawing (steps ST21 and ST22). The prefetch area for drawing with the prefetch offset does not necessarily include the rectangular area for display fully at the time when the drawing is completed. Therefore, there is a possibility that a blank map appears when the back-side drawing memory 11 is interchanged with the front-side drawing memory 12 and a rectangle extracted from the front-side drawing memory is displayed on a display unit immediately after the drawing is completed. For example, when a rightward scroll is carried out in a state shown in FIG. 18, the rectangular area for display is not fully included in the prefetch area for drawing at the time when prefetching and drawing is started. When the rectangular area for display is not fully included in the prefetch area for drawing as a result of the rightward scroll after the prefetching and drawing is completed, a left part of the rectangular area for display goes beyond the front-side drawing memory 12 on which the prefetching and drawing has been carried out. As a result, when the rectangle is extracted from the front-side drawing memory and is displayed on the display unit 15, the rectangle appears as a blank map. In order to prevent this blank map from appearing, the prefetch inclusion determination unit 17 determines whether or not the rectangular area for display is fully included in the prefetch area for drawing, and, when the prefetch inclusion determination unit, in step ST22, determines that the rectangular area for display is fully included in the prefetch area for drawing, the memory interchanging unit 13a interchanges the front-side drawing memory 12 and the back-side drawing memory 11 (step ST11). At that time, the memory interchanging unit also changes the prefetching and drawing start determination area to the one calculated by the prefetch area for drawing calculating unit 7a (refer to FIG. 19). In contrast, when the rectangular area for display is not fully included in the prefetch area for drawing, the memory interchanging unit does not carry out the interchange and the change. A rectangle extracting unit 14 displays an area which corresponds to the rectangular area for display from the front-side drawing memory 12 on the display unit 15, thereby being able to display a map while preventing any blank map from appearing on the display unit.

In FIG. 18, (a) shows the front-side and back-side drawing memories at the time when the prefetching and drawing is started, (b) shows the front-side and back-side drawing memories at the time when the front-side and back-side drawing memories are interchanged immediately after the prefetching and drawing is completed. Further, in FIG. 19, (a) shows the front-side and back-side drawing memories at the time when the prefetching and drawing is started, (b) shows the front-side and back-side drawing memories at the time when the rectangular area for display is fully included in the prefetch area for drawing. Further, in FIGS. 18 and 19, 1800a and 1900a denote the rectangular area for display, 1800b and 1900b denote the prefetching and drawing start determination area, and 1800c and 1900c denote the area which is drawn in the back-side drawing memory 11.

As mentioned above, because the map scrolling device in accordance with Embodiment 2 shifts the prefetch area for drawing by the prefetch offset according to the scroll direction and the scroll speed, and carries out prefetching and drawing, the map scrolling device can prevent the rectangular area for display from going beyond the prefetch area for drawing at the time when the prefetching and drawing is completed even though the scroll speed is high, and can therefore reduce the appearance of a blank map.

As mentioned above, the map scrolling device in accordance with Embodiment 2 includes the scroll detecting unit for detecting the scroll speed of a scroll operation performed on a displayed map, the scroll direction detecting unit for detecting the scroll direction of the scroll operation, the rectangular area for display monitoring unit for acquiring the position of a rectangular area for display on the map, the prefetching and drawing start determining unit for determining whether or not to carry out prefetching and drawing from the position of the rectangular area for display on the map, the prefetch offset calculating unit for determining a prefetch offset from the scroll speed and the scroll direction, the prefetch size for drawing calculating unit for determining a prefetch size for drawing from the scroll speed and the scroll direction, the prefetch area for drawing calculating unit for determining a prefetch area for drawing from the scroll direction, the prefetch offset, the position of the rectangular area for display, and the prefetch size for drawing, the map data reading unit for reading map data about a map of the prefetch area for drawing, the map drawing unit for drawing the map data read in the back-side drawing memory, the prefetch inclusion determining unit for determining whether or not the position of the rectangular area for display position is included in the prefetch area for drawing, the memory interchanging unit for interchanging the back-side drawing memory with the front-side drawing memory, the rectangle extracting unit for extracting a rectangle corresponding to a map of the rectangular area for display from the front-side drawing memory with which the back-side drawing memory is interchanged, and the display unit for displaying the rectangle extracted. Therefore, the map scrolling device can reduce the appearance of a blank map even when the scroll speed is high.

Further, because in the map scrolling device in accordance with Embodiment 2 the prefetch offset calculating unit refers to the prefetch offset table showing prefetch offsets each of which is predetermined according to a scroll speed and a scroll direction to determine the prefetch offset, the map scrolling device can provide a precise prefetch offset. As a result, the map scrolling device can determine the prefetch size for drawing more surely.

Further, because in the map scrolling device in accordance with Embodiment 2 the prefetch inclusion determining unit determines whether or not the rectangular area for display is fully included in the prefetch area for drawing, the map scrolling device can display the map while preventing a blank map from appearing.

Further, because in the map scrolling device in accordance with Embodiment 2 the memory interchanging unit interchanges the front-side drawing memory and the back-side drawing memory only when the prefetch inclusion determining unit determines that the rectangular area for display is fully included in the prefetch area for drawing, the map scrolling device can surely prevent the appearance of a blank map.

### INDUSTRIAL APPLICABILITY

As mentioned above, when a scroll of an on-screen map causes the rectangular area for display to go beyond a determination area larger than the rectangular area for display, the map scrolling device in accordance with the present invention prefetches data about an area extending in the scroll direction and draws the data, thereby implementing the scroll smoothly. Therefore, the map scrolling device in accordance with the present invention is suitable for use in carrying out a map scroll in a map display device.

1. A map scrolling device comprising:
a scroll detecting unit for detecting a scroll speed of a scroll operation performed on a displayed map;
a scroll direction detecting unit for detecting a scroll direction of said scroll operation;
a rectangular area for display monitoring unit for acquiring a position of a rectangular area for display on the map;
a prefetching and drawing start determining unit for determining whether or not to carry out prefetching and drawing from the position of said rectangular area for display on the map;
a prefetch size for drawing calculating unit for determining a prefetch size for drawing from said scroll speed and said scroll direction;
a prefetch area for drawing calculating unit for determining a prefetch area for drawing from said scroll speed, said scroll direction, and said prefetch size for drawing;
a map data reading unit for reading map data about a map of said prefetch area for drawing;
a map drawing unit for drawing the map data read in a back-side drawing memory;
a memory interchanging unit for interchanging said back-side drawing memory with a front-side drawing memory; a rectangle extracting unit for extracting a rectangle corresponding to a map of said rectangular area for display from the front-side drawing memory with which the back-side drawing memory is interchanged; and
a display unit for displaying said rectangle extracted.

2. The map scrolling device according to claim 1, wherein the prefetching and drawing start determining unit determines whether or not to carry out the prefetching and drawing by determining whether the rectangular area for display has gone beyond a predetermined prefetching and drawing start determination area.

3. The map scrolling device according to claim 1, wherein the prefetch size for drawing calculating unit determines the prefetch size for drawing by making reference to a prefetch for drawing size table showing prefetch sizes for drawing each of which is predetermined according to a scroll direction and a scroll speed.

4. The map scrolling device according to claim 1, wherein the prefetch area for drawing calculating unit calculates the prefetch area for drawing from the scroll direction, the scroll speed, the prefetch size for drawing, and the position of the rectangular area for display in such a way that portions of the prefetch area for drawing except that extending in the scroll direction are reduced in size and the prefetch area for drawing is biased toward the scroll direction.

5. The map scrolling device according to claim 1, wherein the memory interchanging unit interchanges the back-side drawing memory and the front-side drawing memory at a time when the prefetching and drawing is completed.

6. A map scrolling device comprising:
a scroll detecting unit for detecting a scroll speed of a scroll operation performed on a displayed map;
a scroll direction detecting unit for detecting a scroll direction of said scroll operation;
a rectangular area for display monitoring unit for acquiring a position of a rectangular area for display on the map;
a prefetching and drawing start determining unit for determining whether or not to carry out prefetching and drawing from the position of said rectangular area for display on the map;
a prefetch offset calculating unit for determining a prefetch offset from said scroll speed and said scroll direction;
a prefetch size for drawing calculating unit for determining a prefetch size for drawing from said scroll speed and said scroll direction;
a prefetch area for drawing calculating unit for determining a prefetch area for drawing from said scroll direction, said prefetch offset, the position of said rectangular area for display, and said prefetch size for drawing;
a map data reading unit for reading map data about a map of said prefetch area for drawing;
a map drawing unit for drawing the map data read in a back-side drawing memory;
a prefetch inclusion determining unit for determining whether or not the position of said rectangular area for display is included in said prefetch area for drawing;
a memory interchanging unit for interchanging said back-side drawing memory with a front-side drawing memory;
a rectangle extracting unit for extracting a rectangle corresponding to a map of said rectangular area for display from the front-side drawing memory with which the back-side drawing memory is interchanged; and
a display unit for displaying said rectangle extracted.

7. The map scrolling device according to claim 6, wherein the prefetch offset calculating unit refers to a prefetch offset table showing prefetch offsets each of which is predetermined according to a scroll speed and a scroll direction to determine the prefetch offset.

8. The map scrolling device according to claim 6, wherein the prefetch inclusion determining unit determines whether or not the rectangular area for display is fully included in the prefetch area for drawing.

9. The map scrolling device according to claim 6, wherein the memory interchanging unit interchanges the front-side drawing memory and the back-side drawing memory only when the prefetch inclusion determining unit determines that the rectangular area for display is fully included in the prefetch area for drawing.
